(19) United States
(12) Patent Application Publication
(10) Pub. No.: US 2013/0264832 A1
(43) Pub. Date: Oct. 10, 2013

(54) TEMPORARY CLOSURE DEVICE OF AN OPENING ELEMENT ON A SUPPORT ELEMENT

(71) Applicant: BOULAY PLASTIQUES, Grez sur Loing (FR)

(72) Inventors: Patrice Boulay, Grez sur Loing (FR); Barthélémy Gagnon, La Genevraye (FR)

(21) Appl. No.: 13/750,701

(22) Filed: Jan. 25, 2013

(30) Foreign Application Priority Data
Jan. 26, 2012 (FR) 1250747

(51) Int. Cl. E05B 65/12

(52) U.S. Cl. CPC E05B 83/36
USPC 292/289

(57) ABSTRACT

A temporary closure device of an opening element on a support element and more particularly a temporary closure device of an opening element on a support element having a wall of the support element comprising an interior surface, an exterior surface and at least one main bore passing through the wall. The main bore has at least first and second surfaces substantially opposite, the device comprising a body, a base and at least one main means of non-elastic or non-mobile fastening to cooperate with the main bore. The device comprises at least one lock mounted mobile in relation to the body, the lock having at least two positions alternatively open or closed, the closed position defined so that the lock is able to come into contact and press against at least the second surface of the main bore to suppress any degree of mobility of the main means of fastening.

### RELATED APPLICATION

The present application claims priority to French Application No. 1250747 filed Jan. 26, 2012, which is herein incorporated by reference in its entirety.

### TECHNICAL FIELD

The invention relates to a temporary closure device of an opening element on a support element. The invention relates more particularly to a temporary closure device of a door or of a mobile element of a motor vehicle, for example a hatch or a cover, on the body of said vehicle.

### BACKGROUND

During the painting of motor vehicle bodies, on assembly lines, the opening elements, such as the doors, are already mounted on the body so that all of the elements are painted at the same time. However, these opening elements are not yet provided with their means of closure, such as a lock allowing them to be locked on the body. In addition to the painting of motor vehicle bodies, this problem exists for all protective treatment steps of bodies before the final assembly of the vehicles.

In order to prevent an untimely opening of the opening elements during the operations of manufacturing vehicles, it is known to use temporary closure devices for these elements.

Patent application FR 2926102 A1 describes, for example, such a temporary closure device. More precisely, this document discloses a temporary closure device of an opening element on a support element, with the support element comprising a wall comprising an interior surface, an exterior surface and two bores passing through said wall, said closure device comprising a body comprising means for blocking the opening element and at least two means of fastening on the support element, each cooperating with a corresponding bore, said device characterized in that a first means of fastening comprises: a first elastic tab, comprising a free end provided with a retaining hook, said tab being flexible elastically in order to allow for the passage of said hook, through the first bore, from the exterior surface to the interior surface during the assembly or from the interior surface to the exterior surface during the disassembly; and a locking element of the elastic tab, mobile between a retracted position and a set position wherein said locking element limits the bending of the first elastic tab, locking as such the retaining hook, against the interior surface of the wall.

Moreover, patent application FR 2889227 A1 describes a device for temporarily separating an opening element on a fixed element of a body of a motor vehicle, comprising, on the one hand, a fastening plate intended for the anchoring of the device in the fixed element, and on the other hand, a body attached to the fastening plate and forming a stop able to serve as a support for the opening element, characterized in that the fastening plate comprises at least two fastening members forming spouts, with at least one being mounted mobile in relation to the fastening plate in such a way as to be able to pass alternatively from a removed position wherein the smallest distance between the fastening members is minimal, to an engaged position wherein the smallest distance between the fastening members is maximal.

Such devices have in particular as disadvantages the requiring of substantial manipulations in particular when the latter require a specific tooling suited to remove them from the support element which results in substantial labor time per operator and per vehicle and consequently an additional cost also due to the purchase of dedicated tooling.

Moreover, such devices can sometimes be substantially fragile when their system of fastening comprises elastic elements. However, the fragility of such a device can produce finishing defects resulting from incidents during the operations of painting degrading as such the quality of the production and delaying, furthermore, the speed of the assembly line by generating, therefore, substantial prejudice.

### SUMMARY

The invention aims to overcome all or a portion of the disadvantages of prior art by proposing a temporary closure device of an opening element on a support element of which the fastening, as its removal, are reliable, simple and rapid.

In an embodiment, a temporary closure device of an opening element on a support element, with the support element comprising a wall comprising an interior surface, an exterior surface and at least one main bore passing through said wall, the main bore having at least a first and a second surfaces which are substantially opposite. The device having a body having means for blocking the opening element, at least one main means of non-elastic fastening in order to cooperate with the main bore of the support element, the main means of fastening having, an end to penetrate into the main bore and come up against the interior surface of the wall in a hooked position, a base having at least one degree of mobility arranged in the main bore and able to come into contact and press against at least the first surface of said corresponding main bore, a base able to come up against the exterior surface of the wall in the hooked position; said device characterized in that it comprises at least one lock, which is mounted mobile in relation to said body, the lock having at least two positions respectively open or closed, the closed position being defined in such a way that said lock is able to come into contact and press against at least the second surface of the main bore in order to suppress any degree of mobility of the main means of fastening.

Such a configuration makes it possible in particular to be free of an elastic tab consequently making it possible to improve the reliability of the device. Moreover, such a lock can be mobile from its open position to its closed position, and inversely, via simple manual action due to the fact that the latter requires only to come into contact and press against at least the second surface of the bore in order to suppress any degree of mobility of the means of fastening and as such lock the temporary closure device of the opening element on the support element.

The temporary closure device can be molded in one piece. Such an embodiment makes it possible to reduce the unit cost of such a device while still offering satisfactory resistance to the various mechanical stresses.

In an embodiment, the lock is mounted mobile in rotation or in translation on the body between its open position and its closed position, such a mobility in particular by rotation making it possible to improve the maneuverability of the lock.

In an embodiment, the lock is integral with the base by means of a flexible zone formed by a flexible elastic web. Moreover, in the case where the elastic web has a certain width, the latter will make it possible to provide an easy guidance of the lock, in particular, but not exclusively, when said lock is mobile in rotation, and when the movement of rotation is carried out around an axis of rotation, said axis of rotation being collinear to an axis according to the width of said elastic web.

The base can extend laterally on either side of the body in order to stabilize its position thrust against the exterior surface of the wall in the hooked position.

In an embodiment, the lock comprises a body, which has at least an apical end, defined as the end able to come into contact and press against at least the second surface of the main bore in order to suppress any degree of mobility of the main means of fastening, and a distal end in order to manipulate the lock, with the apical end having a section of which the area changes in an increasing manner by separating from said apical end.

Such a configuration of the apical end allows for increased facility in setting the lock in place when the latter is placed in the main bore. Indeed, the smaller the area of the apical end section is in relation to the dimensions of the main bore, the more easily the lock can be guided in its movement, in particular when it is being set into place.

In an embodiment, the temporary closure device comprises a means for guiding in order to guide the lock in its movement from the open position, respectively closed, to the closed position, respectively open, with this means for guiding able to be, for example, a slideway.

Moreover, in order to provide for the optimum security of the closed position of the lock which still allowing for easy removal, said temporary closure device can have a means of anchoring the lock in its closed position, with this means of anchoring the lock in its closed position being, for example, a protrusion located in the means for guiding.

In an embodiment, the temporary closure device comprises a secondary means of non-elastic or non-mobile fastening in order to cooperate with a secondary bore of the support element, the secondary means of fastening having an end to penetrate into the secondary bore and come up against the interior surface of the wall in a hooked position, a base having at least one degree of mobility arranged in the secondary bore.

The presence of a secondary means of fastening such as described makes it possible to assert the stability of the device and can also be a means for guiding the operator in the setting in place of the temporary closure device. Indeed, in the case where the two means of fastening, main and secondary, are aligned according to a reference axis, or a longitudinal axis of the body of the device, the latter can allow the operator to facilitate the setting in place of the means of fastening in their respective bores.

In order to substantially increase the implementation for the installation and/or the removal of the temporary closure device, the end of the secondary means of fastening forms an anchor foot intended to be introduced into the secondary bore by swinging.

In an embodiment, the temporary closure device is made of a plastic material. This allows said temporary closure device to be resistant, recyclable, and inexpensive in terms of material.

### BRIEF DESCRIPTION OF THE DRAWINGS

Other characteristics and advantages of the invention shall appear when reading the following detailed description, in reference to the accompanying figures, in which:

FIGS. 1 and 2 depict views of a temporary closure device comprising a lock in a closed position.

FIGS. 3 and 4 depict views of a temporary closure device comprising a lock in an open position.

FIG. 5 depicts a bottom view, as a partial cross-section, of a temporary closure device.

FIGS. 6 and 7 depict views of a temporary closure device comprising a lock in open and closed positions.

FIG. 8 depicts a detailed view of the different positions of a means of blocking of a temporary closure device.

FIG. 9 depicts a view of a temporary closure device.

FIG. 10 depicts an overall view of a body of a motor vehicle having a support element.

FIGS. 11 and 12 depict views of an opening element of a motor vehicle.

FIGS. 13 and 14 depict views of a temporary closure device arranged on a support element of a body of a motor vehicle, the temporary closure device comprising a lock, which is shown in open and closed position in front views.

FIG. 15 depicts a rear view of a temporary closure device arranged on a support element of a body of a motor vehicle.

FIG. 16 depicts a view of a temporary closure device arranged on a support element of a body of a motor vehicle and against which is thrust an opening element.

For increased clarity, identical or similar elements are marked with the same reference signs on all of the figures.

### DETAILED DESCRIPTION

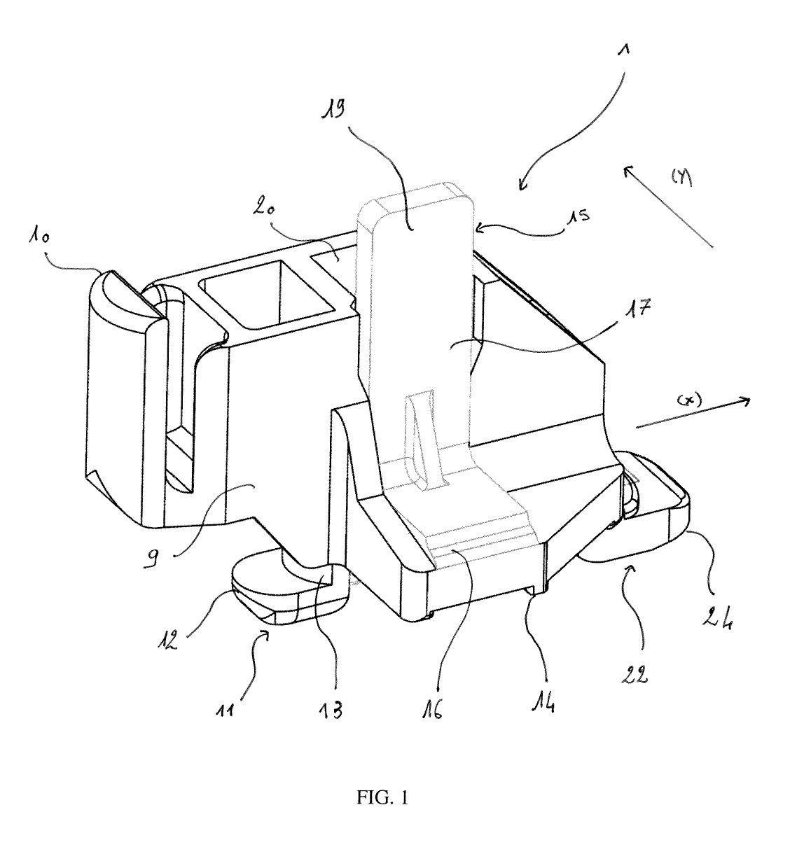

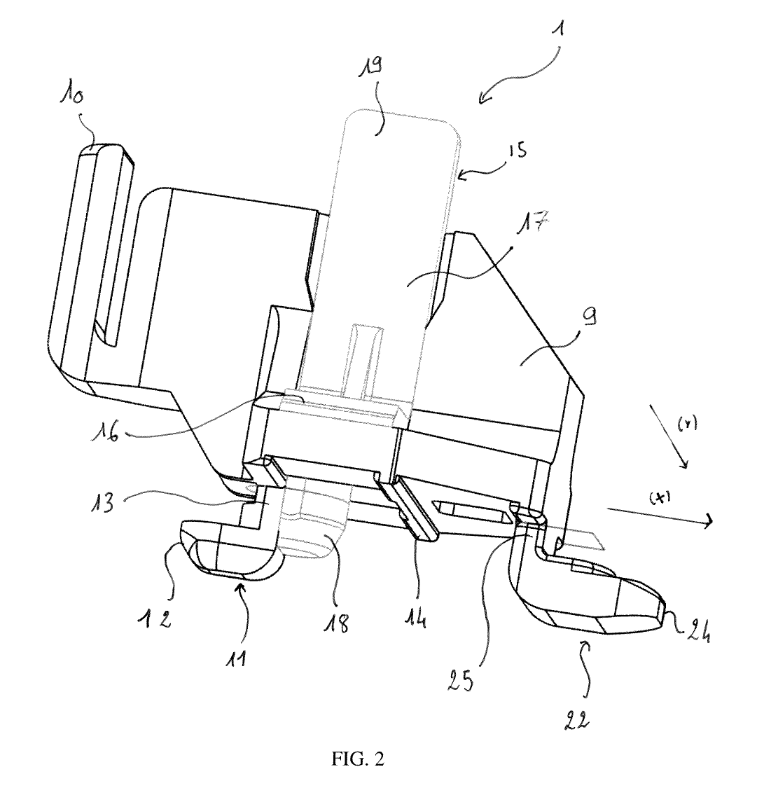

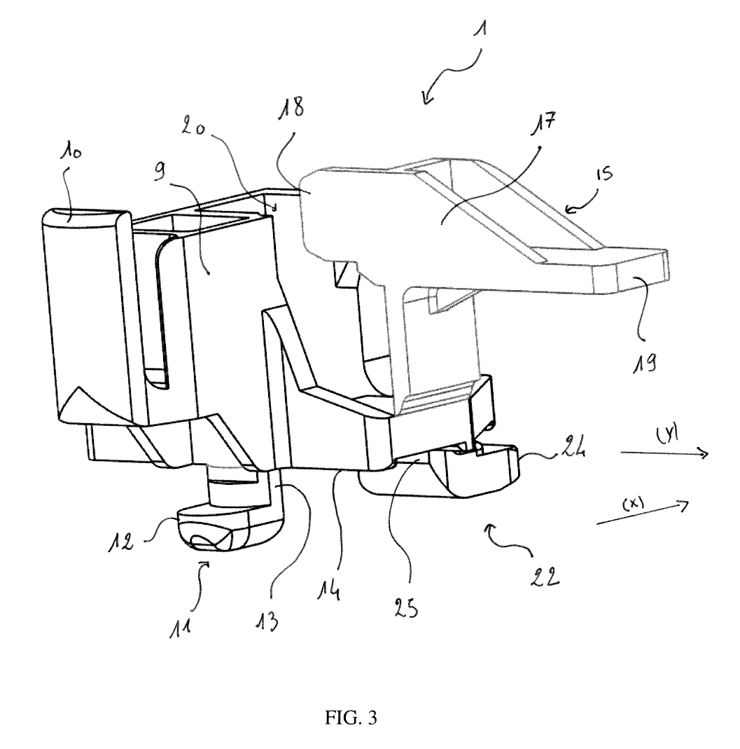

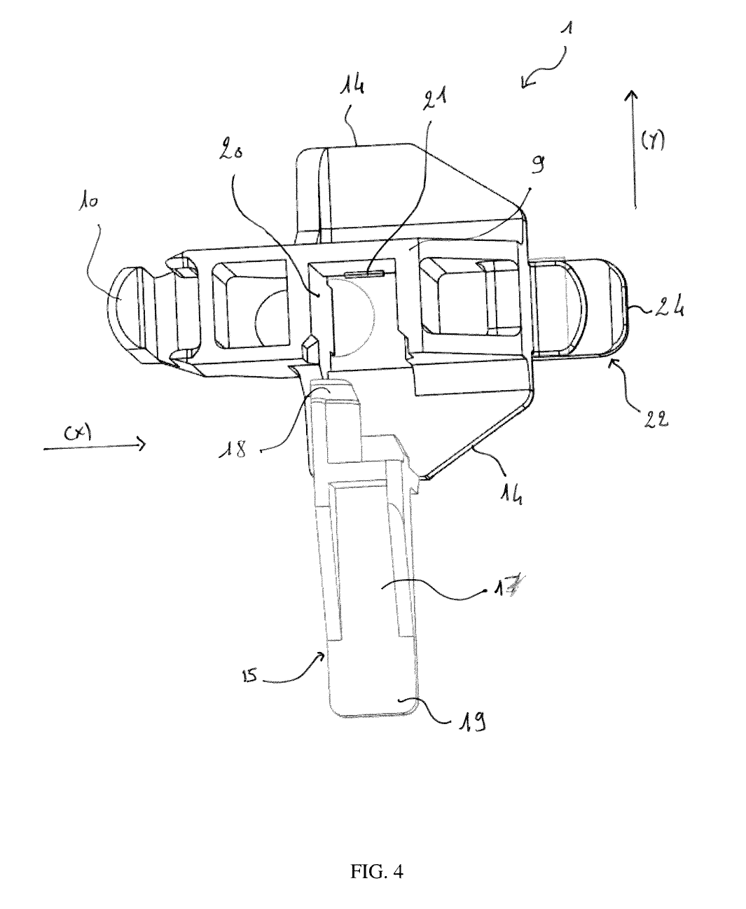

FIGS. 1 to 4 show diagrams under different views of a temporary closure device according to a first embodiment.

These figures show more particularly a temporary closure device 1 of an opening element 2 on a support element 3. In this embodiment, the temporary closure device 1 is made of a one-piece molded plastic material, with the opening element 2 being a door of a motor vehicle, or a mobile element, and the support element 3 being a fixed element of an automobile body.

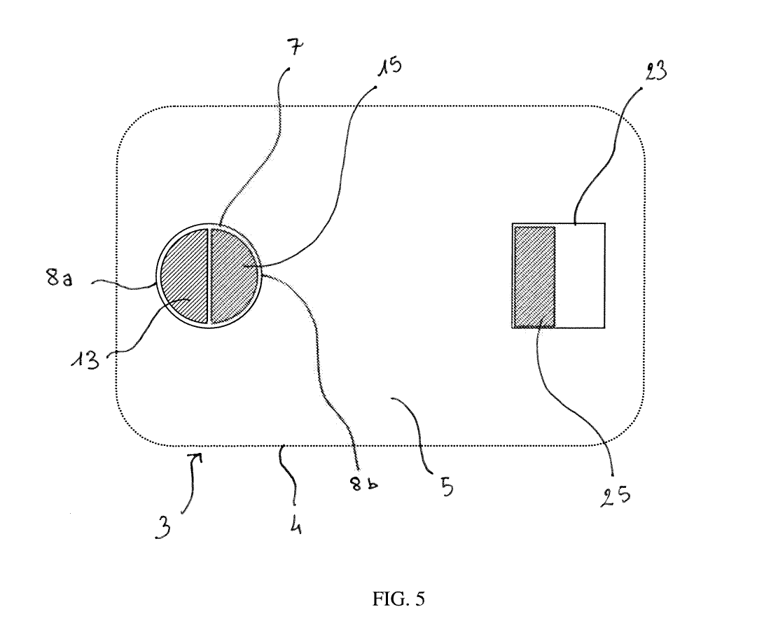

Moreover, the support element 3 (not shown in this figure) comprises a wall 4 comprising an interior surface 5, an exterior surface 6 and at least one main bore 7 passing through said wall 4, the main bore 7 having a first 8a and a second 8b surfaces which are substantially opposite (see FIG. 5).

The temporary closure device 1 comprises a body 9 comprising means of blocking 10 the opening element 2, a main means of non-elastic or non-mobile fastening 11 in order to cooperate with the main bore 7 of the support element 3, the main means of fastening 11 presenting an end 12 in order penetrate into the main bore 7 and come up against the interior surface 5 of the wall 4 in a hooked position, a base 13 having a degree of mobility arranged in the main bore 7 and able to come into contact and press against the first surface 8a of said corresponding main bore, and a base 14 able to come up against the exterior surface 6 of the wall 4 in the hooked position;

Said temporary closure device 1 further comprises a lock 15, which is mounted mobile in rotation in relation to said body 9, the lock 15 having at least two positions alternatively open or closed, the closed position being defined in such a way that said lock 15 is able to come into contact and press against at least the second surface 8b of the main bore 7 in order to suppress any degree of mobility of the main means of fastening 11.

In order to provide for the movement of rotation of the lock 15 in relation to the body 9, said lock 15 is made integral with the base 14 by means of a flexible zone 16 formed by a flexible elastic web, with the latter allowing for an easy implementation during the molding of the part and offering the resistance required for fastening the lock 15 onto the body 9.

As the flexible zone 16 is formed by a flexible elastic web, the rotation of the lock 15 in relation to said body 9 is carried out around a reference axis (x) according to an axis longitudinal to the temporary closure device 1, said reference axis (x) is also collinear to an axis according to the width of said flexible zone 16.

Furthermore, the base 14 able to come up against the exterior surface 6 of the wall 4 in the hooked position, extends laterally on either side of the body 9 in order to stabilize its said thrust position in the hooked position.

The lock 15 described in this embodiment comprises a body 17, which has an apical end 18, defined as the end able to come into contact and press against the second surface 8b of the main bore 7 in order to suppress any degree of mobility of the main means of fastening 11, and a distal end 19 in order to manipulate the lock 15, with the apical end 18 having a section of which the area changes in an increasing manner by separating from said apical end 18.

This geometry allows the apical end 18 to substantially define a truncated cone along the length of which a first wall substantially hugs the shape of the second surface 8b in order to optimize the contact surface of the latter and a second wall, here substantially planar, is able to come into contact with the base 13, which is able to come into contact and press against the first surface 8a of said corresponding main bore.

This configuration consequently makes it possible, when the lock is in closed position, to suppress any degree of mobility of the main means of fastening 11 when said main means of fastening 11 is arranged in the main bore 7 of the support element 3.

According to one embodiment, not shown, the distal end 19 can form with the body 17 of the lock 15 an angle substantially between 30 and 50 degrees, more preferably substantially equal to 45 degrees.

In another embodiment, the distal end is in this case directed opposite the flexible zone 16, this making it possible to facilitate the manipulation of the lock, in particular when it entails unlocking it to remove the temporary closure device 1 from the support element 3.

In order to improve the translation of the lock 15 in relation to said body 9 and make it possible to guide the apical end 18 in the main bore 7, the body 9 of the temporary closure device 1 includes a means for guiding 20 in order to guide the lock 15 in its movement of rotation.

The means for guiding described in the embodiment have a substantially tubular cavity, orthogonal to the base 14 and with a section substantially in the shape of a U in such a way as to have three walls and an opening defining, when the walls guide the lock 15, a connection of the slideway type. The cavity comprises more precisely: a first wall opposite the lock, two lateral walls in order to provide the function of guiding for said lock 15 and an opening in order to allow for the rotation of the lock 15 without hindrance. Furthermore, said first wall comprises a means of anchoring 21 the lock 15 in its closed position, which is formed by a protuberance located in the means for guiding 20, and more particularly a longilineal protrusion according to the reference axis (x) suppressing any degree of mobility of the lock in its closed position.

In an embodiment, the body 17 of the lock has a tab standing substantially orthogonally in relation to said body 17, with this tab being connected at one of its ends to said body 17 of the lock and at its other end, to the flexible zone 16 formed by a flexible elastic web, with this flexible zone 16 having a thickness less than that of the tab. In this non restrictive example, the tab is substantially straight and extends according to an axis substantially orthogonal to the reference axis (x).

Other embodiments, not shown, here can provide that the tab extend according to an axis forming with the reference axis (x) an angle substantially between 30 and 50 degrees, more preferably 45 degrees, with the rotation of the lock 15 in relation to said body 9 being carried out around the reference axis (x).

This angle can vary substantially according to the shape of the device and the positions in particular, of the zone on which one of the ends of the tab must be integral with the base 14 by the intermediary of the flexible zone 16, and of the zone on which the other of the ends of the tab integral with the lock 15 must bring said lock 15 into a slideway connection with the means for guiding 20 formed here by the substantially tubular cavity.

This embodiment makes it possible to adapt the configuration of the lock 15 according to the shapes of each of the elements of the temporary closure device 1, for example of the base 14, which is arranged in order to stabilize the thrust position of said temporary closure device 1.

Moreover, the temporary closure device 1 comprises a secondary means of fastening 22, which is non-elastic and non-mobile, in order to cooperate with a secondary bore 23 of the support element 3, with the secondary means of fastening 22 having an end 24 to penetrate into the secondary bore 23 and come up against the interior surface 5 of the wall 4 in a hooked position, a base 25 having at least one degree of mobility arranged in the secondary bore 23, where the end 24 of the secondary means of fastening 22 forming an anchor foot intended to be introduced into the secondary bore 23 by swinging.

The body of such a temporary closure device 1 can be arranged manually on a support element 3 by inserting by swinging of the end 24 of the secondary means of fastening 22 forming an anchor foot in the secondary bore 23 of the support element 3, with the swinging being a movement of rotation according to an axis (y) orthogonal to the reference axis (x), the lock 15 being in open position, and inserting, in the continuity of the movement of swinging, of the end 12 of the main means of fastening 11, also forming an anchor foot, in the main bore 7 of the support element 3, the lock 15 being in open position, translating according to the reference axis in order to place the base 13 of the main means of fastening 11 in contact and pressing against the first surface 8a of the main bore 7, the lock 15 being in open position, and setting in place of the lock in closed position, i.e., rotation of the lock 15 according to the reference axis (x) in order to place the apical end 18 in contact and pressing against the second surface 8b of the main bore 7 in order to suppress any degree of mobility of the main means of fastening 11.

In order to remove the temporary closure device 1 from the support element 3, the reverse operations can be implemented.

Furthermore, the two ends 12, 24 of the means of fastening respectively main 11 and secondary 22 each form a fixed anchor foot, said anchor feet being aligned according to the reference axis (x) and arranged in such a way that they are opposite one another, thus providing a better maintaining of the device on the support element 3.

FIG. 5 shows a bottom view, as a partial cross-section of a temporary closure device according to this same embodiment. This drawing more particularly shows an interior surface 5 of a wall 4 of a support element 3 whereon is arranged a temporary closure device 1 of which a lock 15 is arranged in closed position. The wall 4 described here has a thickness substantially equal to 2.5 mm and is more preferably between 1 mm and 3.5 mm so that the device provides an optimum maintaining while still retaining a facility for putting it in place.

For increased readability of the drawing, the various parts of the temporary closure device 1 are arranged slightly spaced between each other, the contacts and the pressing between the various parts are therefore not shown here.

In this view and in such a configuration, the following are represented as a cross-section: the base 13 of the main means of fastening 11 is arranged in the main bore 7 in contact and pressing against the first surface 8a of said main bore 7; the lock 15 is arranged in contact and pressing against the second surface 8b of the main bore 7 in order to suppress any degree of mobility of the main means of fastening 11; the base 25 of the secondary means of fastening is arranged in the secondary bore 23, in contact and pressing against a surface of said secondary bore 23.

In this embodiment the main bore 7 has a substantially circular shape and the secondary bore 23 has a substantially rectangular shape. Moreover, the base 13 of the main means of fastening 11 has a section with a substantially half-disc shape and the base 25 of the secondary means of fastening 22 has a section of substantially rectangular shape.

The shapes of the bases of the main 11 and secondary 22 means of fastening, in particular their base 13, 25, as well as the associated main 7 and secondary 25 bores have as such shapes that cooperate at least locally while still providing their respective functions.

Of course this embodiment is not restrictive and it can be considered that these shapes differ.

For example, these shapes can be substantially reversed: the main bore 7 can have a substantially rectangular shape, the secondary bore 23 can have a substantially circular shape, the base 13 of the main means of fastening 11 then having a section with a substantially rectangular shape and the base 25 of the secondary means of fastening 22 having a section with a substantially half-disc shape.

Moreover, the section in this same view of the lock 15 is of a shape that is substantially complementary with that of the base 13 of the main means of fastening 11 in relation to the main bore 11 and also has a section of a substantially half-disc shape.

These shapes can be different from those described (hexagonal, octagonal, etc.) or be similar to each other (the two bores can be circular or rectangular). In the case where the shapes of the main 11 and secondary 23 bores differ, this offers the advantage of providing a foolproof device function for the setting in place of the temporary closure device 1.

More generally, the shapes of the sections in this view of the lock 15 and of the base 13 of the main means of fastening 11 are more preferably complementary in relation to that of the main bore 11.

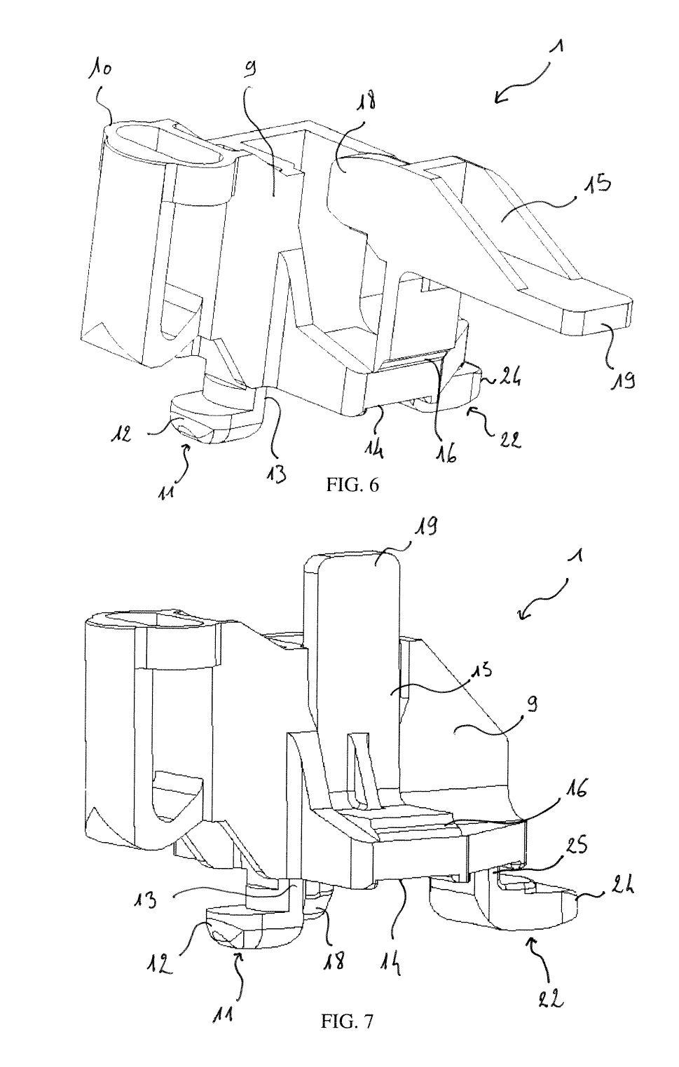

FIGS. 6 and 7 show views of a temporary closure device according to an embodiment comprising a lock, which is in open and closed positions.

This embodiment is distinguished by the means of blocking 10 shaped differently, said means of blocking 10 being adapted according to their interfaces with the opening element 2.

FIGS. 6 and 7 show a means of blocking 10 of the tab type, integral with the body 9 of the temporary closure device 1 by the intermediary of three flexible fasteners: a lower flexible fastener 101 fixed to a first end 110 of the means of blocking and to the body 9, substantially on base 14; and two upper flexible fasteners 102, 103 each fixed laterally to a second end 120 of the means of blocking and to the body 9. The means of blocking 10 of the tab type being arranged substantially orthogonally to the base 14 of the temporary closure device 1, and laterally to said body 9 of the temporary closure device 1 in such a way that said tab is closer to the main means of fastening 11 than the secondary means of fastening 22. In an embodiment, as shown in FIGS. 6 and 7, said tab is located in the same alignment with the anchor feet of the main 11 and secondary 22 means of fastening, according to the reference axis (x).

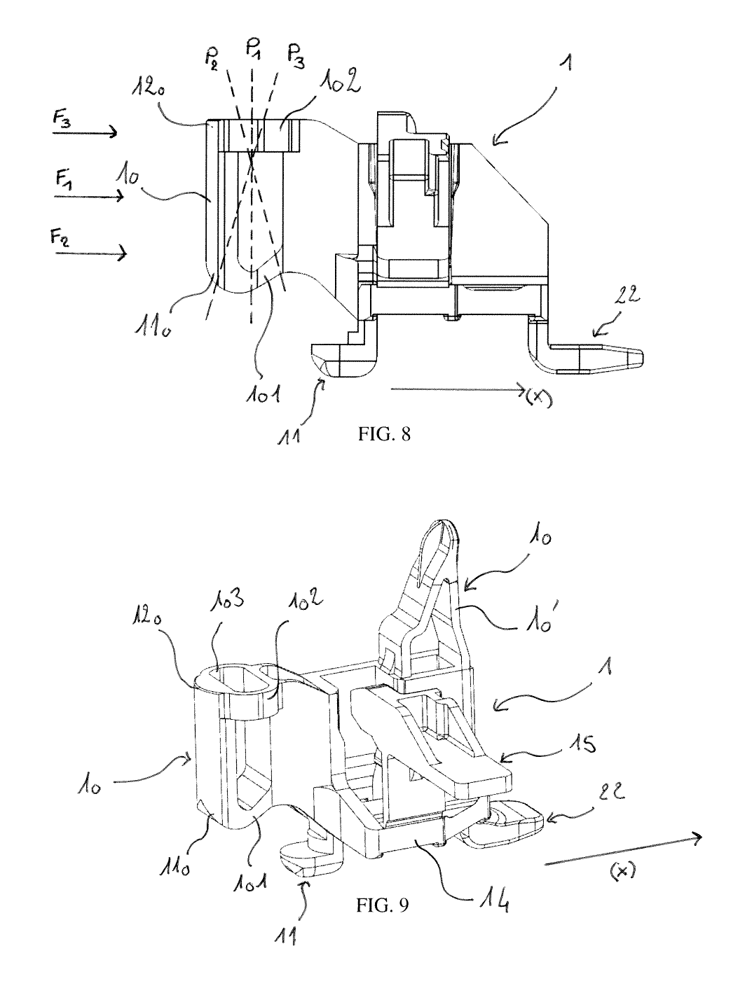

According to the zone where a mobile element of the body comes into contact, when it is closed, with the means of blocking 10 of the temporary closure device 1, the elastic deformation of said means of blocking resulting from the absorption of the kinetic energy by the flexible fasteners 101, 102, 103 would position the means of blocking at least according to three orientations. Indeed, these positions and orientations can be the following (see FIG. 8):

first orientation: in the case where a force F1 is applied transversally substantially at the centre of means of blocking 10, with the kinetic energy being distributed and absorbed substantially uniformly in the flexible fasteners, the elastic deformation created as such makes it possible to place the means of blocking in a first position P1 close to the body 9, with the first and second ends 110, 120 of the means of blocking 10 being substantially equidistant from the body 9;

second orientation: in the case where a force F2 is applied transversally substantially to the first end of the means of blocking 10, the lower flexible fastener 101 is then largely solicited and consequently undergoes a deformation that is more substantial than the two upper flexible fasteners 102, 103: the elastic deformation created as such makes it possible to place the means of blocking in a second position P2 such that, the first end 110 of the means of blocking is closer to the body 9 than the second end 120;

third orientation: in the case where a force F3 is applied transversally substantially to the second end of the means of blocking 10, the two upper flexible fasteners 102, 103 are then largely solicited and consequently undergo a deformation that is more substantial than the lower flexible fastener 101: the elastic deformation created as such makes it possible to place the means of blocking 10 in a third position P3 such that, the second end of the means of blocking is closer to the body 9 than the first end.

Moreover, the flexible fasteners 101, 102, 103 of the means of blocking 10 to the body 9 of the temporary closure device can work by bending independently.

Contrary to this embodiment, the embodiment shown in FIGS. 1 to 5 comprises only one lower flexible fastener resulting in the fact that the means of blocking would be positioned substantially only according to the third position P3.

FIG. 9 shows a view of a temporary closure device according to another embodiment. This embodiment is distinguished at least in that it further comprises an elastically deformable protruding portion 10′, forming a means of blocking 10, in such a way that, once engaged in the mobile element, this protruding portion 10′ is able to provide for the blocking of it and the retaining of said mobile element.

More precisely, this protruding portion 10′ is arranged on an upper portion of the body 9 of the temporary closure device 1 and aligned substantially with the secondary means of blocking 22 according to an axis substantially orthogonal to the base 14.

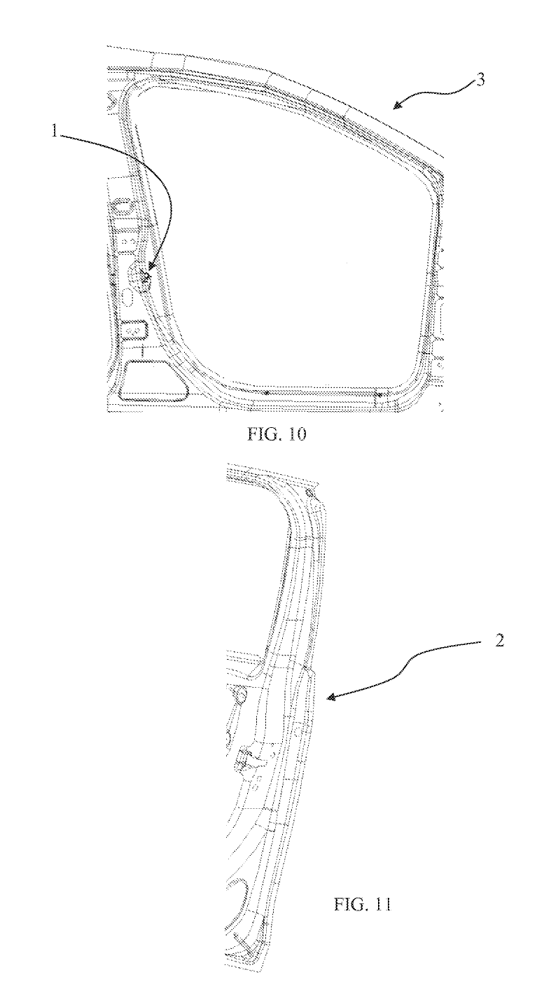

FIG. 10 shows an overall view of a body of a vehicle having a support element 3 and whereon is fixed a temporary closure device 1 according to an embodiment.

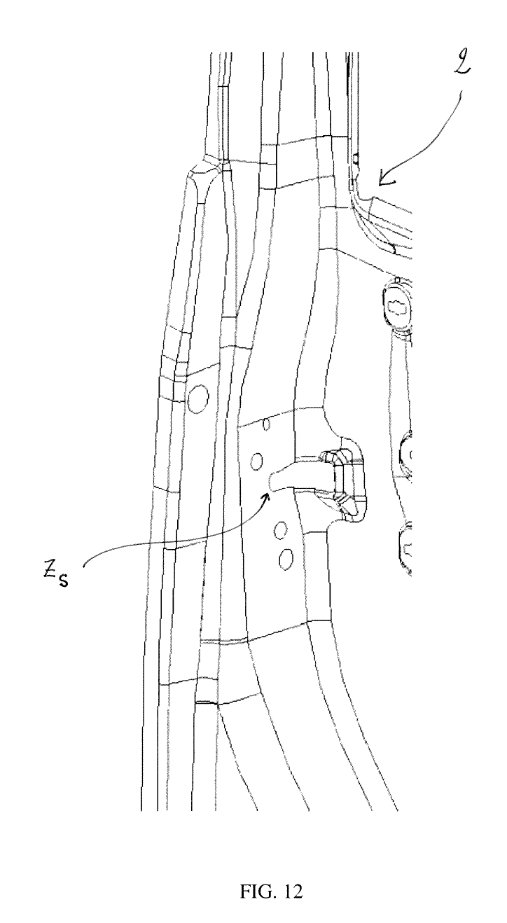

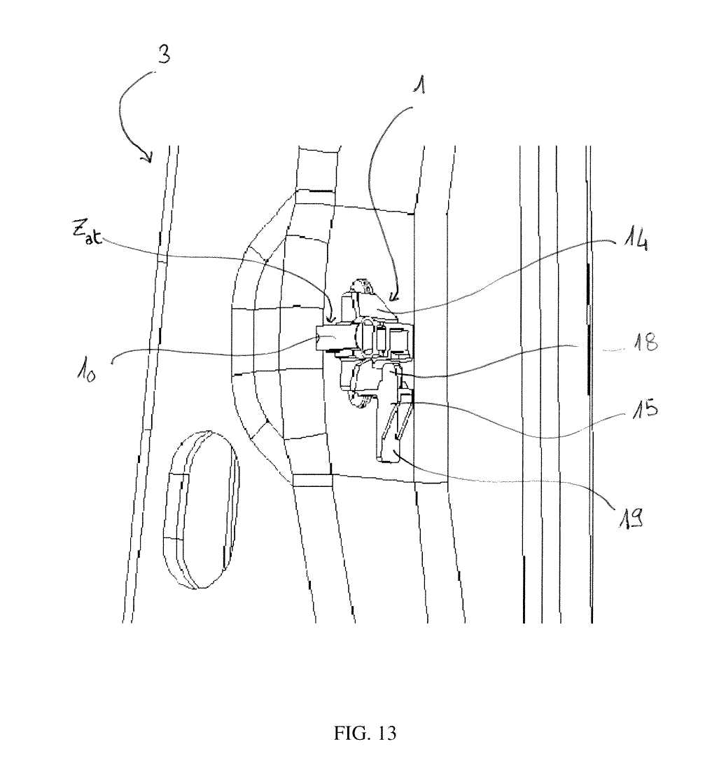

FIGS. 11 and 12 show views of an opening element 2, in particular a front door box of a motor vehicle, or a mobile element of a body of the motor vehicle, with FIG. 9 showing the opening element 2 as a whole and FIG. 12 showing a zone able to come against the temporary closure device 1, also referred to as the lock strike plate zone Zs (see FIG. 12).

“Strike plate” refers to the metal interface pierced and fixed to the doorframe of a door wherein the means of blocking come to engage.

Indeed, the contact between the temporary closure device 1 and the opening element 2 is located on its means of blocking 10 defining an anti-contact zone Zat (see FIG. 13).

“Anti-contact” refers to the fact that the closure device prevents any deformation of the opening element and of the support element by contact with the parts between themselves.

As such, when the opening element 2 is closed, the temporary closure device 1 passes through a lock strike plate housing and comes to block said opening element 2 by the intermediary of the means of blocking 10 as such providing its thrust function against said opening element 2.

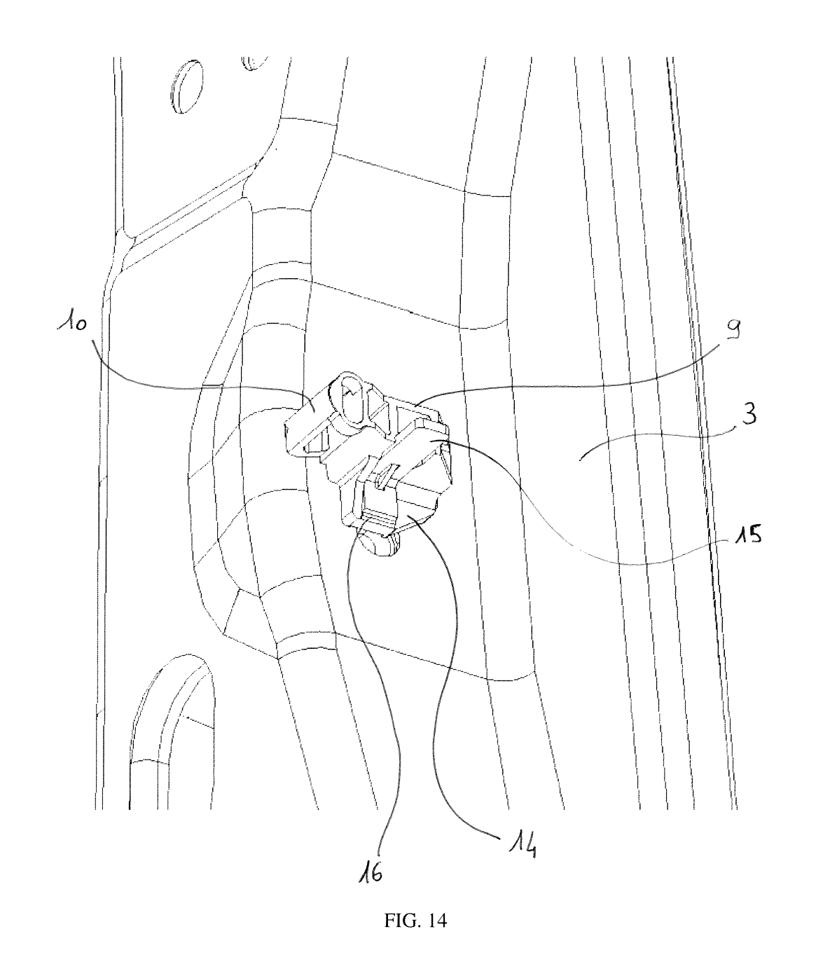

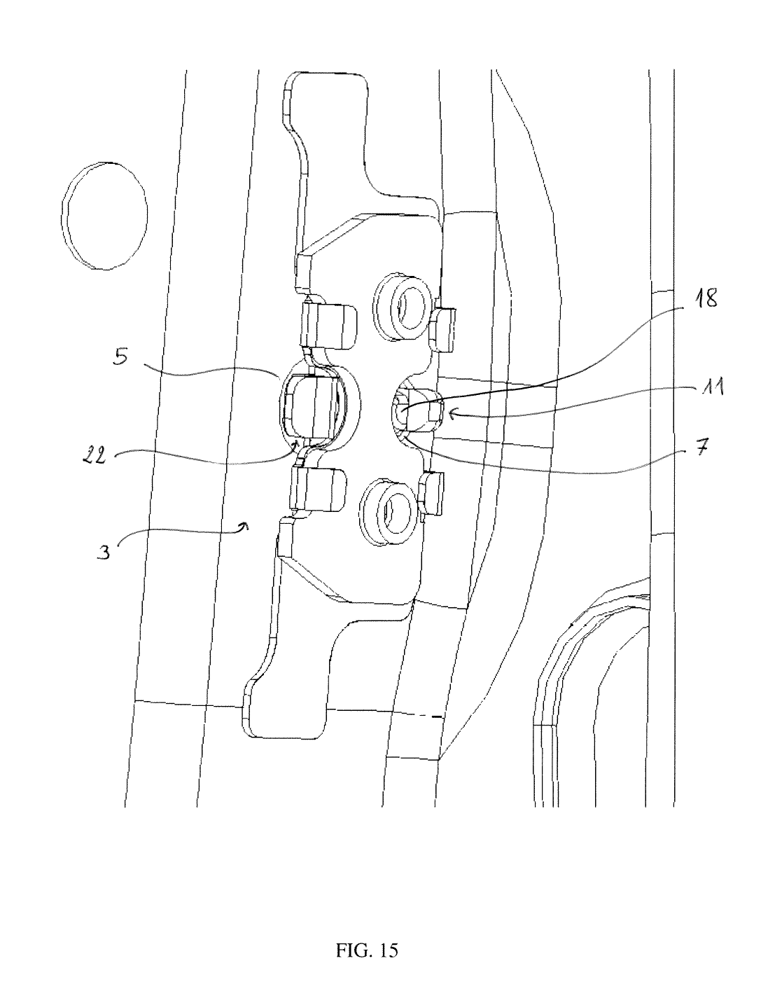

FIGS. 13 and 14 show views of a temporary closure device 1 according to this same embodiment arranged on a support element 3 of an automobile body, the temporary closure device 1 comprising a lock 15, which is shown in open position (FIG. 10) and closed position (FIG. 11), each one as front views.

FIG. 15 shows a rear view of a temporary closure device 1 according to this same embodiment arranged on a support element 3.

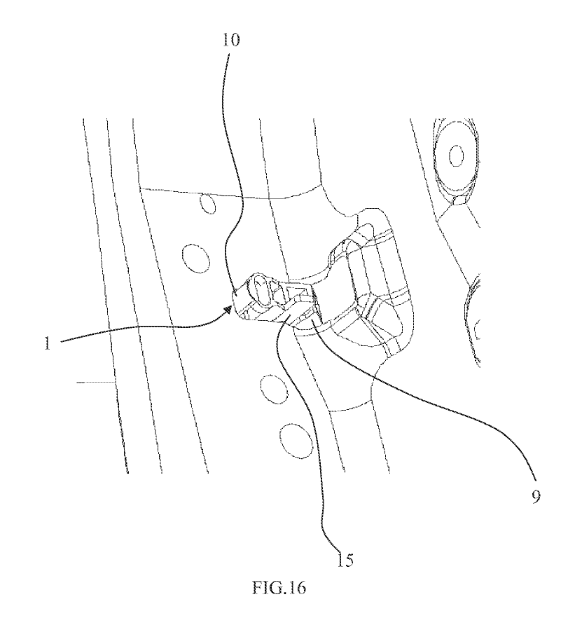

FIG. 16 shows a view of a temporary closure device 1 arranged on a support element 3 of a body and against which is thrust an opening element 2 according to an embodiment.

Many modifications can be made to the embodiments described hereinabove without leaving the scope of the invention.

As such, the general shapes are shown here only for the purposes of illustration.

For example, in the figures shown here the main 11 and secondary 22 means of fastening can be inverted in such a way that the secondary means of fastening 22 is then located on the side of the means of blocking 10 of the opening element 2, the main means of fastening 11 then being still aligned with said secondary means of fastening 22 according to the reference axis (x) and arranged together in such a way that they are opposite one another. This provides in the same way for a better maintaining of the device on the support element 3. In this case the main 7 and secondary 23 bores are of course also inverted.

In addition, the main bore can comprise several contact and pressing surfaces making it possible to provide the same function. Furthermore, the shapes of the lock and of the bore can also differ while still providing the same function which is to suppress any degree of mobility of the main means of fastening 11.

Moreover, the section of the bores can be different and not only rectangular and circular as described here. Indeed, many shapes can be used while still providing the same function.

Finally, the temporary closure device can be realized as a single piece or not as a single piece.

1. A temporary closure device of an opening element on a support element, the support element comprising a wall comprising an interior surface, an exterior surface and at least one main bore passing through said wall, the main bore having at least a first and a second surfaces which are substantially opposite, said device comprising:
a body comprising means of blocking the opening element;
at least one main means of non-elastic or non-mobile fastening in order to cooperate with the main bore of the support element, the main means of fastening having:
i. an end to penetrate into the main bore and come up against the interior surface of the wall in a hooked position;
ii. a base having at least one degree of mobility arranged in the main bore and able to come into contact and press against at least the first surface of said corresponding main bore;
a base able to come up against the exterior surface of the wall in the hooked position;
said device comprising at least one lock, which is mounted mobile in relation to said body, the lock having at least two positions alternatively open or closed, the closed position being defined in such a way that said lock is able to come into contact and press against at least the second surface of the main bore in order to suppress any degree of mobility of the main means of fastening, said temporary closure device being molded in one piece.

2. The temporary closure device according claim 1, wherein the lock is mounted mobile in rotation or translation on the body between its open position and its closed position.

3. The temporary closure device according to claim 1, wherein the lock is integral with the base by means of a flexible zone formed by a flexible elastic web.

4. The temporary closure device according to claim 1, wherein the base extends laterally on either side of the body in order to stabilize its position thrust against the exterior surface of the wall in the hooked position.

5. The temporary closure device according to claim 1, wherein the lock comprises a body, the body comprising:
an apical end, said apical end able to come into contact and press against at least the second surface of the main bore in order to suppress any degree of mobility of the main means of fastening; and
a distal end in order to manipulate the lock;
the apical end having a section of which the area changes in an increasing manner by separating from said apical end.

6. The temporary closure device according to claim 1, further comprising a means for guiding in order to guide the lock in its movement from the open position, respectively closed, to the closed position, respectively open.

7. The temporary closure device according to claim 1, further comprising a means of anchoring the lock in its closed position.

8. The temporary closure device according to claim 7, wherein the means of anchoring the lock in its closed position is a protrusion located in the means for guiding.

9. The temporary closure device according to claim 1, further comprising a secondary means of non-elastic or non-mobile fastening in order to cooperate with a secondary bore of the support element, with the secondary means of fastening comprising:
an end to penetrate into the secondary bore and come up against the interior surface of the wall in a hooked position; and
a base having at least one degree of mobility arranged in the secondary bore.

10. The temporary closure device according to claim 9, wherein the end of the secondary means of fastening forms an anchor foot intended to be introduced into the secondary bore by swinging.

11. The temporary closure device according to claim 1, wherein the device is made of plastic material.
